(19) United States
(12) Patent Application Publication
(10) Pub. No.: US 2012/0017398 A1
(43) Pub. Date: Jan. 26, 2012

(54) Two-Tooth Hinge

(76) Inventor: Liang Huachun, Bazhou City (CN)

(21) Appl. No.: 13/174,550

(22) Filed: Jun. 30, 2011

(30) Foreign Application Priority Data
Jun. 30, 2010 (CN) 201020241891.7

(51) Int. Cl. E05D 5/10; E05D 5/02

(52) U.S. Cl. 16/386

(57) ABSTRACT

A two-tooth hinge comprises a connector plate, riveting piece, crow foot wrench, spring, riveting pin, and cradle plate, etc. The connector plate and the cradle plate are connected through the riveting piece with the riveting pin and spring. The crow foot wrench is connected to the riveting piece with the riveting pin. The connector plate teeth are on the right side of the plate. The crow foot wrench falls into the grooves of the connector plate teeth. The riveting angle of the connector plate and cradle plate is between σ2-σ1. The hinge can be adjusted at three angles and using the different holes in the connector plate, riveting piece, and cradle plate, the hinge can be adapted to various sofa dimensions.

### FIELD OF THE INVENTION

The invention relates to field of hinges for adjusting sofas and sofa beds and more specifically, hinges that allow for the adjustment of the angle between the seat and back of a steel-framed sofa.

### BACKGROUND OF THE INVENTION

Existing sofas are already rather advanced in their specifications and styles. However, most sofas, even high-end ones, possess only fixed seatbacks that do not allow for angle adjustment.

### SUMMARY OF THE INVENTION

This invention provides a two-tooth hinge that allows for sofa seatback adjustment wherein the range of movement between a connector plate and a cradle plate is between 105°-125°.

This two-tooth hinge utility model can be used for securing furniture, particularly steel-framed sofas, as it allows for three angle adjustments between the seats and backs of the sofas. With the various insertion slots on the spinal plate, riveting piece, and cradle plate, the steel-framed sofas can be adjusted to different dimensions.

### FIGURES

The detailed description is described with reference to the following set of drawings. The same reference numerals provided on different drawings indicate the same or similar items. Other advantages and aspects of the invention will become apparent upon reading the following description of the drawings and detailed description.

FIG. 1 is a diagram of an example embodiment of the invention.

FIG. 2 displays a side axle view of one example embodiment of the invention.

FIG. 3 displays a front view of one example embodiment of the invention.

FIG. 4 displays a view of the hinge adjusted to the widest angle at σ1 according to one example embodiment of the invention.

FIG. 5 displays a view of the hinge adjusted to another angle at σ1 according to one example embodiment of the invention.

FIG. 6 displays a view of the hinge with the connector plate and cradle plate adjusted to a 90° angle according to another example embodiment of the invention.

FIG. 7 displays a three-dimensional view of the hinge according to yet another one example embodiment of the invention.

FIG. 8 displays a perspective view of the hinge according to another example embodiment of the invention.

FIG. 9 displays the positions of the teeth plate, groves, and apex of the hinge according to a still further embodiment of the invention.

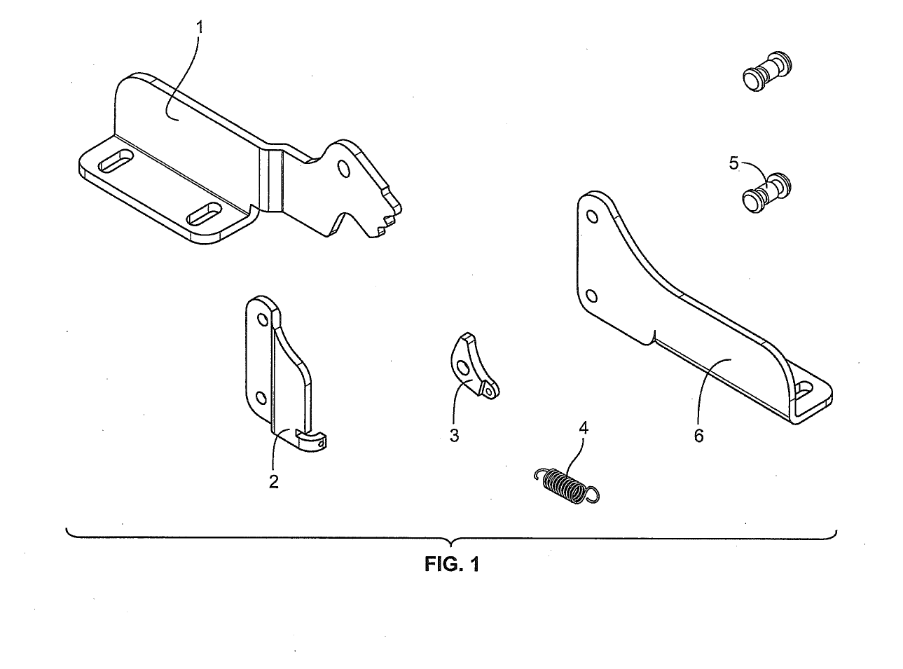

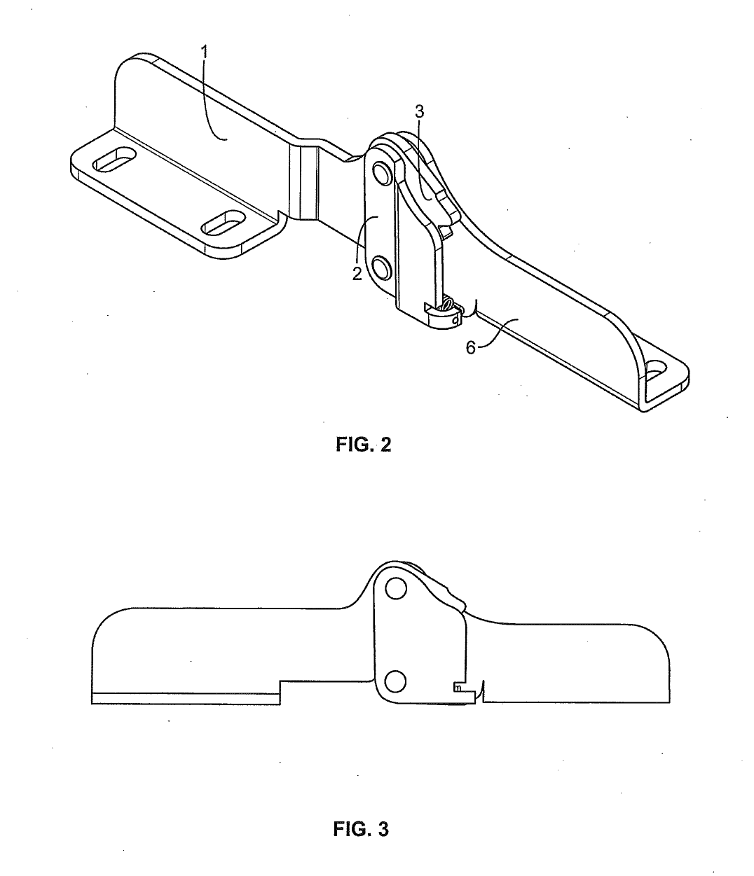

### DETAILED DESCRIPTION OF THE INVENTION

The two-tooth hinge is a home furniture accessory composed of a connector plate 1, riveting piece 2, crow foot wrench 3, spring 4, riveting pin 5, and cradle plate 6. The connector plate 1 is connected to the cradle plate 6 through the riveting piece 2 and the riveting pin 5 and spring 4 attached to the riveting piece. The crow foot wrench 3 is connected to the riveting piece 2 through the riveting pin 5. The right side of the connector plate 1 contains connector plate teeth 7 with teeth grooves 8. The hinge's position can be changed by placing the crow foot wrench 3 in different teeth grooves 8. The riveting angle of the connector plate 1 and cradle plate 6 is between σ2-σ1, or 105° to 125°, with 125° being the largest angle.

When the hinge is entirely horizontal, as depicted in FIG. 3, the tension of the spring 4 allows the crow foot screw 3 to be unsecured, which results in the horizontal positioning of the connector plate 1 and the cradle plate 6:

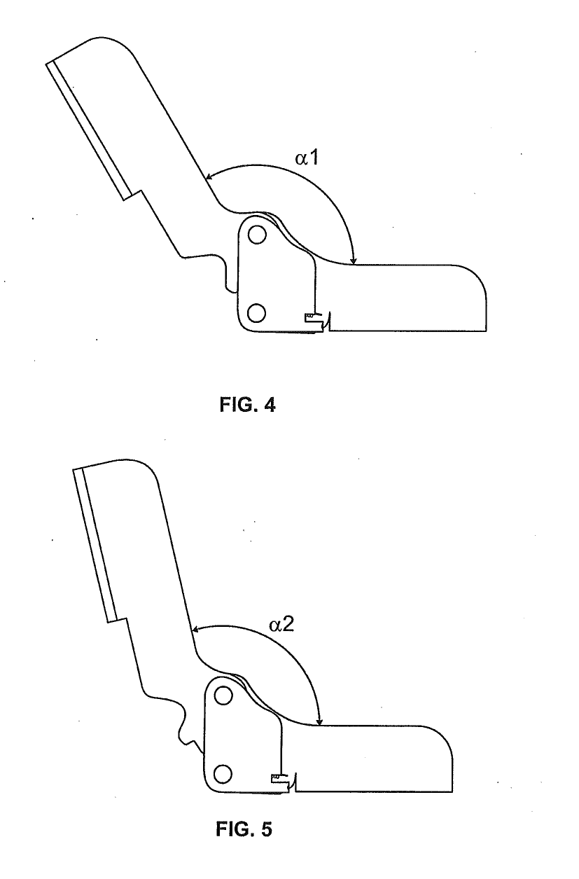

In Position 1, as depicted in FIG. 4, when an external force pushes the connector plate 1 clockwise, the top of the connector plate teeth 9 slides past the top of the crow foot wrench, and the crow foot wrench 3 lands in the first teeth groove 8 of the connector plate teeth 7. The connector plate 1 cannot be moved in a counterclockwise direction and is limited to an angle of σ1.

In Position 2, as depicted in FIG. 5, when an external force pushes the connector plate 1 further clockwise, the crow foot wrench 3 lands in the next teeth groove 8, and the angle formed by the connector plate 1 and cradle plate 6 becomes σ2.

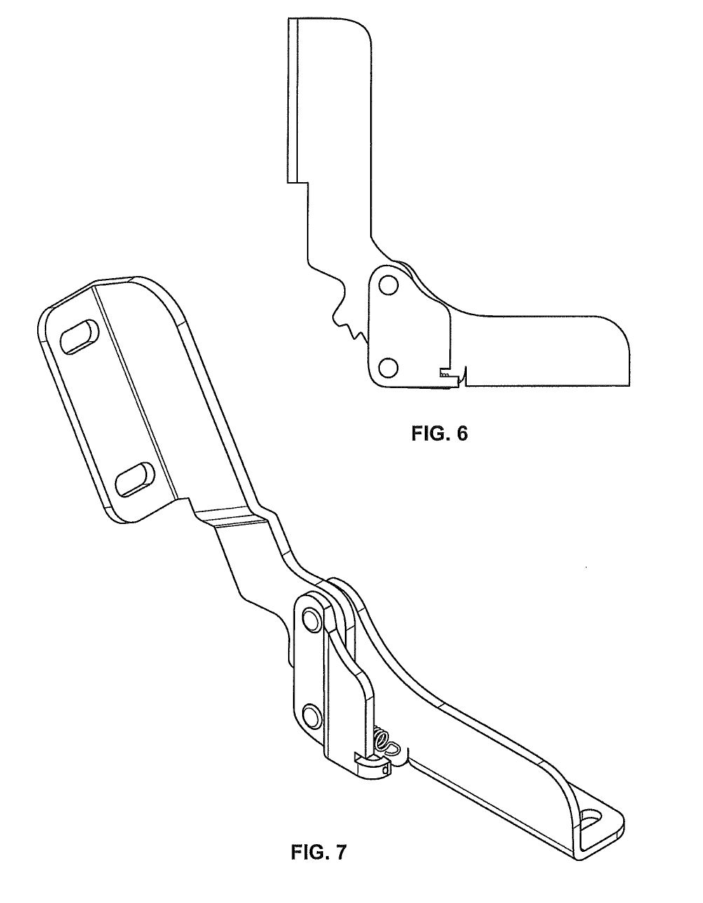

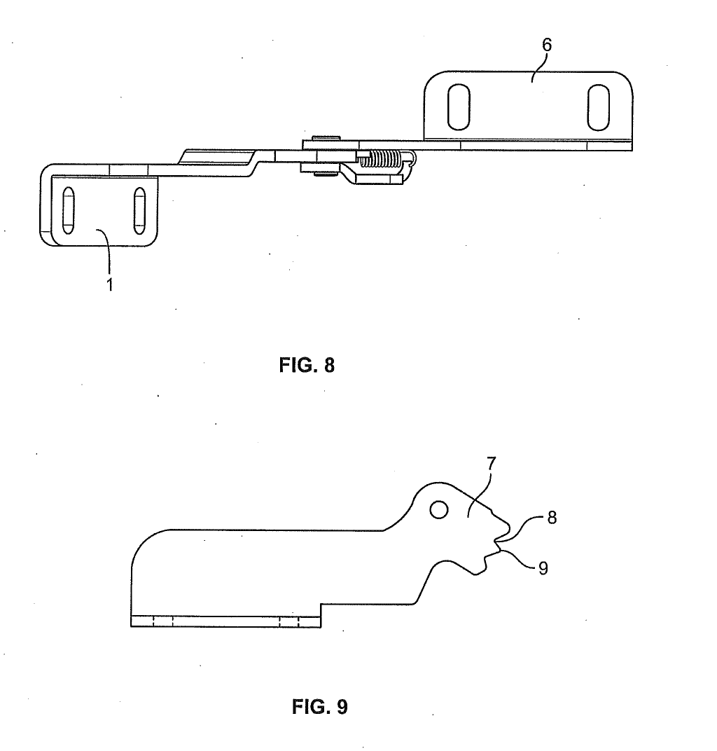

To return to the original position, as depicted in FIG. 6, push the connector plate 1 further clockwise. The top of the crow foot wrench 3 will slide past the connector plate teeth 7 of the connector plate 1, and with no remaining grooves to secure its position, the outer arc of the crow foot wrench 3 will be closely pressed against the outer surface of the connector plate teeth 7 of the connector plate 1. Without the crow foot wrench securing its position, the connector plate 1 can be pushed in a clockwise direction to a horizontal position.

To enhance durability, the crow foot wrench can be manufactured, for example, with agate steel, and the connector plate teeth can be made, for example, from Mn16 materials.

This application claims priority to Chinese patent no. 2010 2 0241891.7 filed in China on Jun. 30, 2010 which is hereby incorporated by reference in its entirety.

While this invention is susceptible of embodiment in many different forms, there are shown in the drawings and will herein be described in detail, examples of the invention with the understanding that the present disclosure is to be considered as an exemplification of the principles of the invention and is not intended to limit the broad aspect of the invention to the examples illustrated.

I claim:

1. A two-tooth hinge comprising:
a connector plate,
a riveting piece,
a crowfoot wrench,
a spring,
a riveting pin, and
a cradle plate, wherein the connector plate and the cradle plate are connected with the riveting pin through the riveting piece and with the spring and further wherein the crowfoot wrench is connected to the riveting piece with the riveting pin.

2. The hinge of claim 1 comprising a set of two teeth located on the right of the connector plate, wherein the crowfoot wrench falls into a set of grooves between the teeth of the connector plate teeth.

3. The hinge of claim 1 comprising a range of movement between the connector plate and cradle plate of approximately 105°- 125°.
